(19) United States
(12) Patent Application Publication
(10) Pub. No.: US 2002/0080597 A1
(43) Pub. Date: Jun. 27, 2002

(54) EL lamp for a front lit display

(75) Inventor: William A. Coghlan, Tempe, AZ (US)

Correspondence Address: Paul F. Wille, Durel Corporation, 2225 West Chandler Boulevard, Chandler, AZ, 85224, US

(73) Assignee: Durel Corporation

(21) Appl. No.: 09/746,381

(22) Filed: Dec. 21, 2000

(51) Int. Cl. F21V 8/00; H05B 33/00

(52) U.S. Cl. 362/31; 349/63; 362/84; 362/330

(57) ABSTRACT

A light guide directs some light from an EL lamp into a display and absorbs or redirects the remaining light in a direction different from the preferred viewing angle for the display, thereby preserving the contrast of the display. The display includes a substantially transparent light guide having a first major surface and a second, opposed major surface and at least two opposed edges. An EL lamp is optically coupled to the light guide along a first of the opposed edges and the light guide includes grooves in one of the major surfaces for re-directing light from the EL lamp out of the one of the major surfaces.

### BACKGROUND OF THE INVENTION

This invention relates to electroluminescent (EL) lamps and, in particular, to an EL lamp for front lighting a display, such as a liquid crystal display.

An EL lamp is essentially a capacitor having a dielectric layer between two conductive electrodes, one of which is transparent. The dielectric layer includes a phosphor powder or there is a separate layer of phosphor powder adjacent the dielectric layer. The phosphor powder emits light in the presence of a strong electric field, using very little current.

A modern EL lamp is a thick film device, typically including a transparent substrate of polyester or polycarbonate material having a thickness of about 7.0 mils (0.178 mm.). A transparent, front electrode of indium tin oxide (ITO) or indium oxide is vacuum deposited onto the substrate to a thickness of 1000 Å or so. A phosphor layer is screen printed over the front electrode and a dielectric layer is screen printed over phosphor layer. A rear electrode is screen printed over the dielectric layer. Other methods for making an EL lamp can be used instead, e.g. roll coating.

In many applications where a display is viewed in daylight or bright ambient light, it is difficult to obtain the desired optical properties from a display that is lighted from the rear, i.e. a display that must be transparent at low light levels and reflective at high light levels. In such applications, it is desirable to use front lighting. Liquid crystal displays are a popular choice for a display because they consume relatively little power and produce a clear, readable image. It is known in the art to front light or to back light a liquid crystal display.

In most applications, a plurality of light emitting diodes (LEDs) provide front lighting for a liquid crystal display. In some applications, very small incandescent lamps are used. In either case, the result is an extremely non-uniform lighting pattern because the sources are bright points of light rather than luminous areas. Small, cold cathode fluorescent lamps have been used but these lamps are relatively expensive.

An EL lamp is particularly useful for backlighting because of the uniform, soft (glare free), omni-directional (lambertian) glow produced by the phosphor. Front lighting with an EL lamp more difficult than with point sources because light is radiating in all directions from a large area, producing much stray light. As used herein, stray light refers to light that cannot be absorbed without interfering with a display or cannot be re-directed to illuminate the display. Stray light is at least annoying in a display and often can make viewing portions of the display difficult; e.g. by reducing the contrast of the display. Any front lighting mechanism must not only be effective but must also be low cost to be commercially viable.

Liquid crystal displays often present additional problems for front lighting because the display has a preferred viewing angle for maximum contrast and because the display includes polarizers. The preferred viewing angle is often the same as the preferred angle for illuminating the display. Thus, in addition to uniformity, brightness, and other considerations, one must illuminate a liquid crystal display in a way that does not interfere with viewing.

It is known in the art to use a light guide for redirecting light from an EL lamp. U.S. Pat. No. 5,806,954 (Butt et al.) discloses a gauge having moving pointer including a translucent substrate with an EL lamp on at least one side of the substrate. The pointer is intended to be viewed directly as a luminous object. It is not intended to illuminate another object. For example, the disclosed pointer is translucent, not transparent. A light guide for front lighting a display must be relatively transparent, e.g. greater than seventy percent, if any portion of the display is covered by the light guide.

It is known in the art to back light a liquid crystal display using a light guide having grooves or having a taper; see U.S. Pat. No. 4,618,216 (Suzawa). It is also known in the art to front light a liquid crystal display with a neon tube surrounding the display; see U.S. Pat. No. 4,842,378 (Flasck et al.).

In view of the foregoing, it is therefore an object of the invention to provide an EL lamp for front lighting a display.

Another object of the invention is to provide a low cost light guide for EL lamps.

A further object of the invention is to provide a liquid crystal display that is front lit by an EL lamp.

### SUMMARY OF THE INVENTION

The foregoing objects are achieved in this invention wherein a light guide directs some light from an EL lamp into a display and absorbs or redirects the remaining light in a direction different from the preferred viewing angle for the display, thereby preserving the contrast of the display. The display includes a substantially transparent light guide having a first major surface and a second, opposed major surface and at least two opposed edges. An EL lamp is optically coupled to the light guide along a first of the opposed edges and the light guide includes grooves in one of the major surfaces for re-directing light from the EL lamp out of the one of the major surfaces.

### BRIEF DESCRIPTION OF THE DRAWINGS

A more complete understanding of the invention can be obtained by considering the following detailed description in conjunction with the accompanying drawings, in which:

FIG. 1 is a plan view of a display constructed in accordance with the prior art;

FIG. 2 is a plan view of a display constructed in accordance with the invention;

FIG. 3 is a cross-section of a display constructed in accordance with one embodiment of the invention;

FIG. 4 is a cross-section of a display constructed in accordance with another embodiment of the invention;

FIG. 5 is a cross-section of a light guide constructed in accordance with the invention;

FIG. 6 is a cross-section of a light guide constructed in accordance with an alternative embodiment of the invention;

FIG. 7 is a cross-section of a light guide constructed in accordance with another alternative embodiment of the invention;

FIG. 8 is a plan view of the light guide illustrated in FIG. 6;

FIG. 9 is a plan view of an alternative embodiment of the invention; and

FIG. 10 is a cross-section of a light guide constructed as illustrated in FIG. 9.

### DETAILED DESCRIPTION OF THE INVENTION

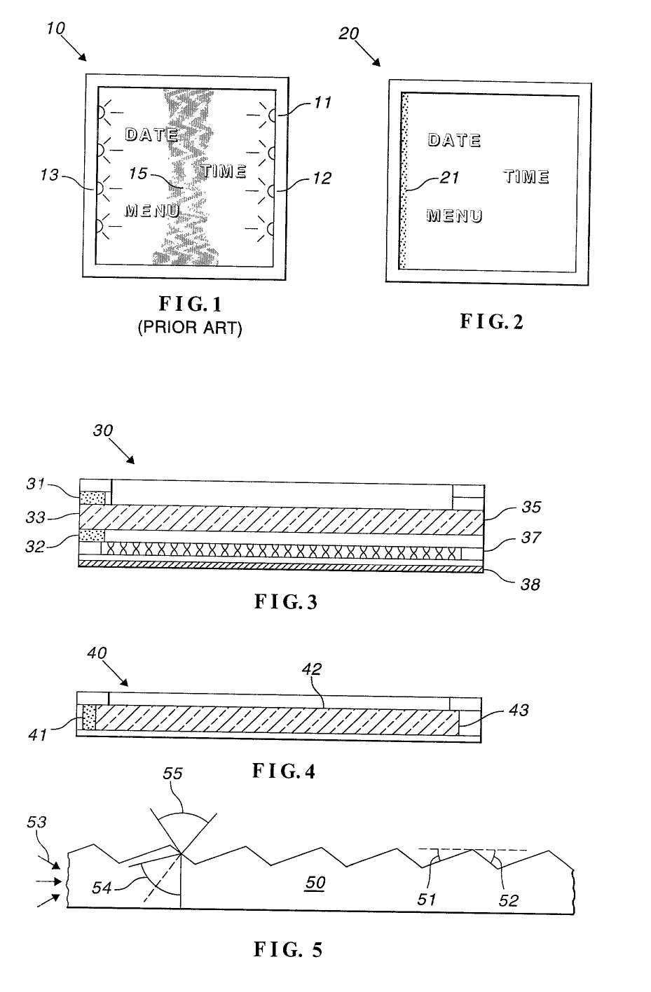

FIG. 1 illustrates a problem with illuminating a display with point sources of light. Display 10 includes point light sources on either side of the display, such as light emitting diodes 11, 12, and 13. The light from these sources produces a noticeably uneven lighting pattern, including shadow 15 centrally located between the rows of light sources. The glare from the sides and the shadow in the middle provide a display that is readable but not optimum.

FIG. 2 illustrates display 20 constructed in accordance with the invention. EL lamp 21, represented by stippling along the left-hand edge of display 20, provides a glare-free, uniform light that spills across the display in a transparent light guide. In accordance with the invention, and explained in greater detail below, light from lamp 21 is either directed downward to the display or away from the line of sight of the viewer. EL lamp 21 is masked from the viewer but can be seen if display 20 is tilted appropriately.

FIG. 3 is a cross-section of a display constructed in accordance with the invention. Display 30 includes EL lamp 31 and EL lamp 32 disposed on opposite major surfaces along the left-hand edge of light guide 33. The width of the EL lamps depends, in part, upon the brightness of the lamps and the area to be illuminated. Generally, each EL lamp is a stripe about one tenth the width of the display, measured in the same direction.

Even while luminous, lamp 31 provides some reflection and scattering of the light from lamp 32 and lamp 32 provides some reflection and scattering of the light from lamp 31. Edge 35, opposite the EL lamps, is preferably polished or coated to provide reflection or painted black to absorb incident light. In either case, the object is to prevent light from escaping through the side of the display. Edge 35 need not be perpendicular to the plane of the display but can be beveled in either direction. Display 30 includes liquid crystal element 37 and a reflective rear surface 38.

In operation, light from EL lamps 31 and 32 is redirected by light guide 33 onto liquid crystal element 37, where it is absorbed or reflected in accordance with the information being displayed. The specific construction of the light guide is described in connection with FIGS. 5-9.

FIG. 4 illustrates an alternative embodiment of the invention wherein EL lamp 41 is located along a narrow edge of light guide 42. In this case, it is preferred that opposite edge 43 be coated or polished to reflect light.

FIG. 5 is a cross-section of a portion of a light guide constructed in accordance with a preferred embodiment of the invention. Light guide 50 is preferably made from polycarbonate or other plastic having an index of refraction greater than approximately 1.5. A higher index of refraction increases the amount of light that is internally reflected. The upper or outer major surface of light guide 50 is preferably faceted or grooved as shown. Each groove has a triangular cross-section with unequal sides. The sides facing the EL lamp (not shown, to the left) are preferably shorter than the sides facing to the right. Stated another way, angle 51, between horizontal and the left-hand facet, is preferably smaller than angle 52, between horizontal and the right-hand facet. In a preferred embodiment of the invention, angle 52 is from approximately 40° to approximately 70°.

Because total internal reflection requires a minimum angle of incidence (relative to normal), represented by angle 54. A fraction of the light incident at less than the critical angle is transmitted from a facet within a range of directions, represented by arc 55. As known to those of skill in the art, the angle of transmission and the magnitude of a ray depend upon the angle of incidence and the index of refraction of light guide 50. The transmitted light is directed to a liquid crystal display (not shown in FIG. 5).

The larger facets provide an increased area for receiving light rays, which are incident at a large angle, from an EL lamp and for reflecting the rays to an adjacent smaller facet, from which the rays are transmitted. Light incident upon lower major surface 54 is either reflected to a small facet, reflected to a larger facet, or refracted at the lower surface and transmitted. Because of the large angle of incidence, little light is transmitted from lower surface 57. Light traveling parallel to lower major surface 54 is preferably absorbed at the right-hand edge of light guide 50. Thus, most of the light, represented by arrows 53, from an EL lamp is redirected to the liquid crystal display or absorbed.

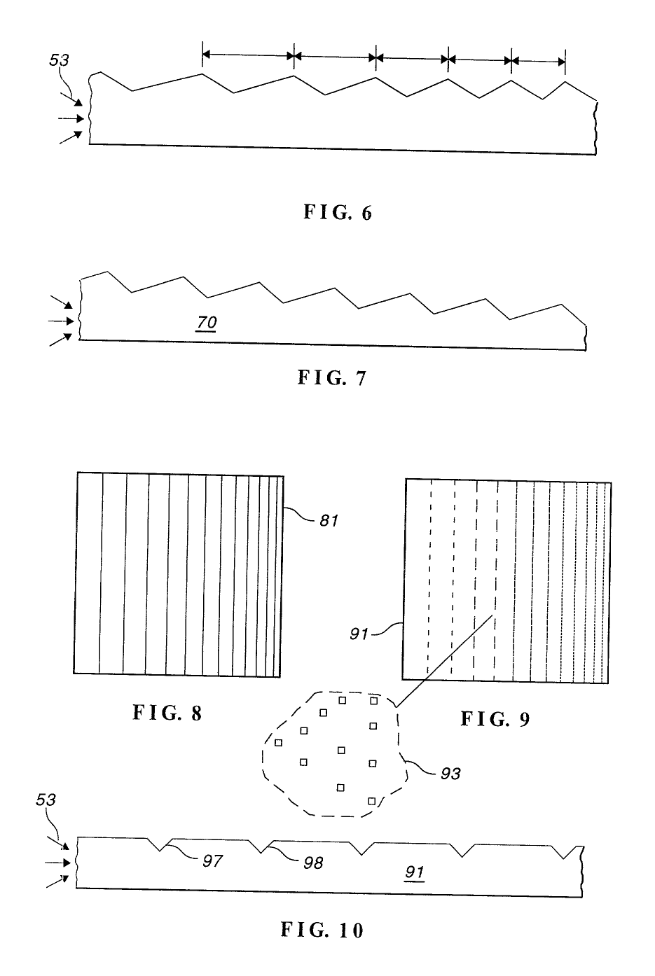

FIG. 6 is a cross-section of an alternative embodiment of the invention in which the grooves are unevenly spaced. In particular, the spacing of the grooves decreases with distance from the light source, represented by rays 53. The change can be linear, i.e. arithmetical, or, preferably, exponential. In this embodiment, the size of the smaller facets is constant and the angle of the smaller facets relative to horizontal is constant. The uneven spacing of the grooves compensates, although not exactly, for the decrease in intensity of the light as one moves away from a light source.

FIG. 7 illustrates an alternative embodiment of the invention in which the angle of the cut is not perpendicular to the plane of the light guide, which has the effect of reducing the thickness of light guide 70 with distance from the light source. Alternatively, one could increase the depth of cut of the grooves, which would change the size and angle of one or both facets as one moved away from the edge coupled to an EL lamp. It is preferred that the angle of the smaller, i.e. the light transmitting facets, be approximately constant across the face of the light guide. FIG. 8 is a plan view of a light guide in which the grooves are non-uniformly spaced and are continuous from edge to edge across light guide 81.

FIG. 9 is a plan view of an alternative embodiment of the invention in which the grooves are discontinuous across light guide 91 and non-uniformly spaced. In other words, one has a series of inverted pyramids in the upper surface of the light guide. The arrangement of FIG. 9 allows one to introduce a randomness into the light guide that makes the light guide less noticeable when viewed directly but as effective as light guide 81. Inset 93 is a magnified view of a portion of the surface of light guide 91. Although illustrated as having a square base, the base of the pyramid can have any convenient number of sides.

FIG. 10 is a cross-section of the embodiment of FIG. 9 in which the indentations are separated by flat portions of the surface of light guide 91. In particular, indentations, such as indentation 97 and indentation 98, are separated from one another by a flat portion of the upper surface of light guide 91. The same construction can be applied to the embodiment of FIG. 8, in which the grooves are separated by flat portions of the upper surface of the light guide.

The invention thus provides an EL lamp for front lighting a display and a low cost light guide for EL lamps. The invention also provides a liquid crystal display that is front lit by an EL lamp.

Having thus described the invention, it will be apparent to those of skill in the art that many modifications can be made with the scope of the invention. For example, the choice of materials for the light guide is not critical, with the understanding that a low index of refraction degrades performance. The color of the EL lamp is a matter of choice to suit a particular application.

What is claimed as the invention is:

1. A front lit display having a light source comprising:
a substantially transparent, light guide having a first major surface and a second, opposed major surface;
said light guide including at least two opposed edges;
a first EL lamp optically coupled to said light guide along a first of said opposed edges;
wherein said light guide includes indentations in said first major surface for redirecting light from said EL lamp out of said first major surface.

2. The display as set forth in claim 1 wherein said light guide has an index of refraction greater than 1.5.

3. The display as set forth in claim 1 wherein said light guide is polycarbonate.

4. The display as set forth in claim 1 wherein said indentations extend pseudo-randomly across said one major surface.

5. The display as set forth in claim 1 wherein said indentations are V-shaped grooves having at least two facets.

6. The display as set forth in claim 5 wherein said grooves have one facet larger than the other facet.

7. The display as set forth in claim 5 wherein said grooves extend continuously across said one major surface.

8. The display as set forth in claim 5 wherein said grooves are uniformly paced.

9. The display as set forth in claim 5 wherein said grooves are non-uniformly spaced.

10. The display as set forth in claim 5 wherein said grooves are spaced in accordance with an arithmetic progression.

11. The display as set forth in claim 5 wherein said grooves are exponentially spaced.

12. The display as set forth in claim 1 wherein said first EL lamp overlies the second of said opposed edges.

13. The display as set forth in claim 1 wherein said first EL lamp overlies a portion of said first major surface.

14. The display as set forth in claim 1 wherein said first EL lamp overlies a portion of said second major surface.

15. The display as set forth in claim 1 and further including a second EL lamp optically coupled to said light guide.

16. The display as set forth in claim 15 wherein said first EL lamp overlies a portion of said first major surface and said second EL lamp overlies a portion of said second major surface.

17. The display as set forth in claim 1 wherein a second of said opposed edges is treated to absorb light.

18. The display as set forth in claim 1 wherein a second of said opposed edges is treated to reflect light.

19. The display as set forth in claim 1 including a liquid crystal element optically coupled to said first major surface.
